(19) United States
(12) Patent Application Publication
(10) Pub. No.: US 2025/0358696 A1
(43) Pub. Date: Nov. 20, 2025

(54) LAYER 1 OR LAYER 2 TRIGGERED MOBILITY

(71) Applicant: ZTE Corporation, Shenzhen (CN)

(72) Inventors: Mengjie ZHANG, Shenzhen (CN); Jing LIU, Shenzhen (CN); He HUANG, Shenzhen (CN); Fei DONG, Shenzhen (CN); Ling YANG, Shenzhen (CN)

(73) Assignee: ZTE Corporation, Shenzhen, GD (CN)

(21) Appl. No.: 19/290,818

(22) Filed: Aug. 5, 2025

Related U.S. Application Data
(63) Continuation of application No. PCT/CN2023/076729, filed on Feb. 17, 2023.

(51) Int. Cl. H04W 36/04; H04L 5/00; H04W 16/28; H04W 36/00

(52) U.S. Cl. CPC H04W 36/04; H04L 5/0051; H04W 16/28; H04W 36/0058

(57) ABSTRACT

In wireless communication, a device may change, add, or handover between cells of network access for inter-cell mobility. This may include Layer 1 and/or Layer 2 (L1/L2) signaling for a user equipment (UE) moving between cells in a network. There may be a configuration message that includes configurations for one or more Layer 1 (“L1”) or Layer 2 (“L2”) Triggered Mobility (“LTM”) candidate cells. A measurement report with L1 measurements for the LTM candidate cells is used for a cell switch command to indicate a target LTM candidate cell to trigger execution of a LTM cell switch to the target LTM candidate cell. The LTM cell switch is from a source cell to the target LTM candidate cell.

### TECHNICAL FIELD

This document is directed generally to wireless communications. More specifically, in a mobile device communications system, there may be improved signaling for inter-cell mobility.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for Layer 1 and/or Layer 2 (L1/L2) signaling for a user equipment (UE) moving between cells in a network. The signaling can reduce the mobility interruption time and/or improve robustness of a handover. The movement may be triggered by the network or the UE. There may be a configuration message that includes configurations for one or more Layer 1 (“L1”) or Layer 2 (“L2”) Triggered Mobility (“LTM”) candidate cells. A measurement report with L1 measurements for the LTM candidate cells is used for a cell switch command to indicate a target LTM candidate cell to trigger execution of a LTM cell switch to the target LTM candidate cell. The LTM cell switch is from a source cell to the target LTM candidate cell.

In one embodiment, a method for wireless communication includes receiving a configuration message that includes configurations for one or more Layer 1 (“L1”) or Layer 2 (“L2”) Triggered Mobility (“LTM”) candidate cells; storing the configurations for the LTM candidate cells; transmitting a measurement report with L1 measurements for at least one of the LTM candidate cells; receiving a cell switch command to indicate a target LTM candidate cell from the LTM candidate cells; and performing a LTM cell switch to the target LTM candidate cell. The configurations for LTM candidate cells comprise at least one of: a list of candidate cell configurations, a list of candidate cell group level configuration (CellGroupConfig), a list of candidate radio bearer configuration (RadioBearerConfig), or a list of candidate measurement configuration (MeasConfig). The configurations for each candidate comprise at least one of: a candidate cell configuration index, a cell group level configuration, or a reference index. The reference index refers to an indicated cell group level configuration from the candidate cell group level configuration list, an indicated radio bearer configuration from the candidate radio bearer configuration list, an indicated measurement configuration from the candidate measurement configuration list, or an indicated candidate cell configuration from the candidate cell list. The configurations for LTM candidate cells comprises groups of configurations for each of the candidate cells, wherein each of the candidate cells in one group share a common or reference configuration, and each of the candidate cells in one group has a delta configuration. The common or reference configuration is referenced with a reference index to refer to the reference configuration from a reference configuration pool. The reference configuration pool comprise at least one of: a list of reference cell configuration, a list of reference cell group level configuration (CellGroupConfig), a list of reference radio bearer configuration (RadioBearerConfig), or a list of reference measurement configuration (MeasConfig). The configurations for LTM candidate cells comprises a common L1 measurement configuration pool. The common L1 measurement configuration pool comprises at least one of: a list of L1 reference signaling (RS) resources for serving cells and LTM candidate cells, a list of beam information for serving cells and LTM candidate cells, or a list of transmission configuration indication (TCI) states information for serving cells and LTM candidate cells. The configurations for LTM candidate cells comprises an information list indicates which of the L1 measurement configurations are associated with which of the candidate cells. An information item in the information list is configured to link RS resource(s) with a candidate cell, beam(s) information with a candidate cell, or TCI state(s) information with a candidate cell. The RS resource, beam information or TCI state is configured for uplink (UL) transmission only, downlink (DL) transmission only, or both UL and DL transmission. The information list is combined with a candidate cell configuration list or is configured within a candidate cell configuration. The measurement report comprises at least one of: a cell identification, a RS identification, a measurement identification, a measurement result, an indication for uplink (UL) synchronization completion, or an indication for timing advance availability. The method includes performing, before receiving the cell switch command, a downlink (DL) synchronization or an uplink synchronization with candidate cells. The method includes sending, a UL signaling to the target LTM candidate cell, to inform the UE arrival to the target LTM candidate cell or the completion of the LTM cell switch. The UL signaling comprises or indicates at least one of: the target LTM candidate cell identification, TCI state indication of the target LTM candidate cell, beam/RS identification of the target LTM candidate cell, or activated/deactiavted SCell identification(s). The method includes starting a first timer, upon reception of the cell switch command, wherein the first timer is stopped upon successful execution of the LTM cell switch. The method includes determining a failure for the execution of the LTM cell switch, based on expiration of the first timer. The method includes starting a second timer, upon reception of the cell switch command or upon detection of the failure for the execution of the LTM cell switch; wherein the second timer is stopped upon successful execution of the LTM cell switch. The method includes performing an execution of the LTM cell switch to another LTM candidate cell, if detection of the failure for the execution of the LTM cell switch and the second timer is running. The method includes triggering a RRC re-establishment procedure, if the second timer expires. A state of the LTM candidate cell comprises at least one of a pre-configured state, a pre-configured but suspended state, a activated state or a deactivated state. For the pre-configured state, a UE stores the cell configuration but does not apply the cell configuration, and the UE performs L1 measurements on the cell, further wherein for the pre-configured but suspended state the UE stores the cell configuration, does not apply the cell configuration, and the UE suspends performing of L1 measurements on the cell.

In another embodiment, a method for wireless communication includes transmitting a configuration message that includes configurations for one or more Layer 1 (“L1”) or Layer 2 (“L2”) Triggered Mobility (“LTM”) candidate cells; receiving a measurement report with L1 measurements for at least one of the LTM candidate cells; and transmitting a cell switch command to indicate a target LTM candidate cell from the LTM candidate cells, and to trigger execution of a LTM cell switch to the target LTM candidate cell. The configurations for LTM candidate cells comprise at least one of: a list of candidate cell configuration, a list of candidate cell group level configuration (CellGroupConfig), a list of candidate radio bearer configuration (RadioBearerConfig), or a list of candidate measurement configuration (MeasConfig). The configurations for each candidate comprise at least one of: a candidate cell configuration index, a cell group level configuration, or a reference index. The reference index refers to an indicated cell group level configuration from the candidate cell group level configuration list, an indicated radio bearer configuration from the candidate radio bearer configuration list, an indicated measurement configuration from the candidate measurement configuration list, or an indicated candidate cell configuration from the candidate cell list. The configurations for LTM candidate cells comprises groups of configurations for each of the candidate cells, wherein each of the candidate cells in one group share a common or reference configuration, and each of the candidate cells in one group has a delta configuration. The common or reference configuration is referenced with a reference index to refer to the reference configuration from a reference configuration pool. The configurations for LTM candidate cells comprise a common L1 measurement configuration pool. The common L1 measurement configuration pool comprises at least one of: a list of L1 reference signaling (RS) resources for serving cells and LTM candidate cells, a list of beam information for serving cells and LTM candidate cells, or a list of transmission configuration indication (TCI) states information for serving cells and LTM candidate cells. The configurations for LTM candidate cells comprises an information list indicates which of the L1 measurement configurations are associated with which of the candidate cells. An information item in the information list is configured to link RS resource(s) with a candidate cell, beam(s) information with a candidate cell, or TCI state(s) information with a candidate cell. The RS resource, beam information or TCI state is configured for uplink (UL) transmission only, downlink (DL) transmission only, or both UL and DL transmission. The information list is combined with a candidate cell configuration list or is configured within the candidate cell configuration. The measurement report comprises at least one of: a cell identification, a RS identification, a measurement identification, a measurement result, an indication for uplink (UL) synchronization completion, or an indication for timing advance availability. The method includes receiving, a UL signaling to the target LTM candidate cell, to inform the UE arrival to the target LTM candidate cell or the completion of the cell switch, wherein the UL signaling comprises or indicates at least one of: the target LTM candidate cell identification, TCI state indication of the target LTM candidate cell, or beam/RS identification of the target LTM candidate cell, or activated/deactivated SCell identification(s).

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows an embodiment of user equipment (UE) intra-DU mobility.

FIG. 5 shows an embodiment of user equipment (UE) intra-CU and inter-DU mobility.

FIG. 6 shows an embodiment of user equipment (UE) inter-CU mobility.

FIG. 7 shows an embodiment of a signaling procedure for L1/L2 triggered mobility (LTM).

FIG. 8 shows one embodiment of a candidate cell group list structure.

FIG. 9 shows one embodiment of a candidate cell signaling structure.

FIG. 10 shows one embodiment of a signaling structure for L1 measurement configuration.

FIG. 11a shows a first embodiment of a configuration signaling structure.

FIG. 11b shows an example cell group configuration from FIG. 11a.

FIG. 11c shows an example cell information list from FIG. 11a.

FIG. 11d shows an example resource configuration pool from FIG. 11a.

FIG. 11e shows an example candidate cell configuration list from FIG. 11a.

FIG. 12 shows a second embodiment of a configuration signaling structure.

FIG. 13 shows a third embodiment of a configuration signaling structure.

FIG. 14 shows example network signaling for LTM.

FIG. 15 shows another example of network signaling for LTM.

FIG. 16 shows an example of cell or cell group (CG) state transfer.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

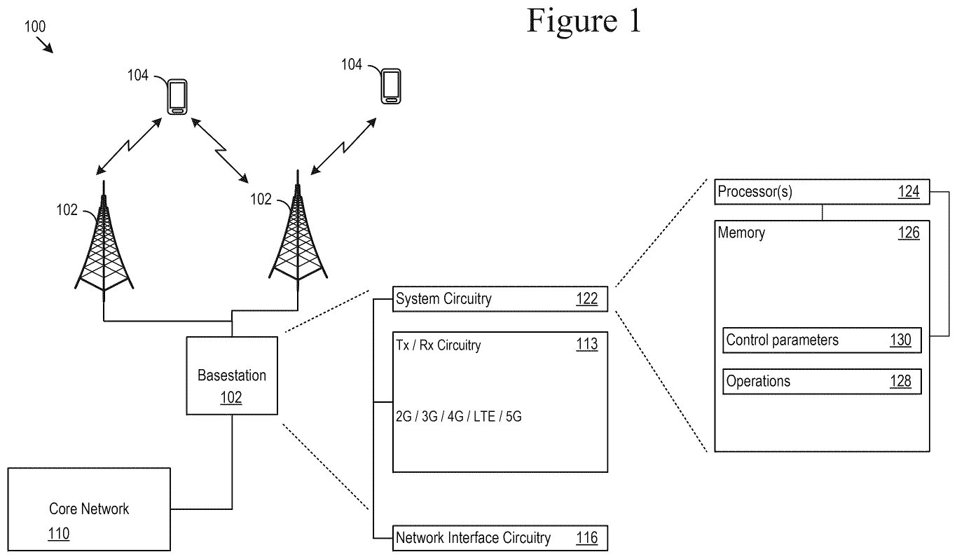

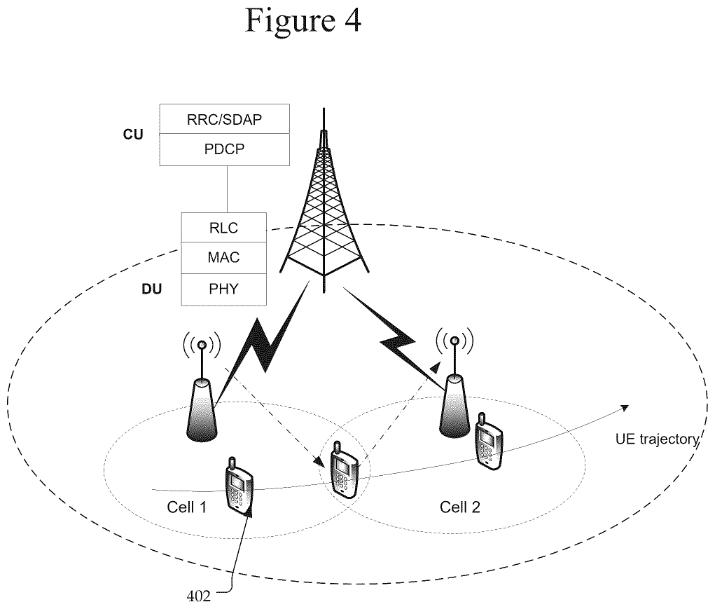

As described below with respect to FIGS. 1-6, a network provider may include a number of network nodes (i.e. basestations) for providing network access to a user equipment (“UE”) device. The network nodes are referred to as basestations in some embodiments. FIGS. 4-6 illustrate cell mobility in which the UE device moves between cells. Control signaling may be used to facilitate this mobility. Control signaling supports the transmission of downlink and uplink transport channels and may be referred to as layer 1 and/or layer 2 (“L1/L2”) signaling, indicating that the corresponding information partly originates from the physical layer (Layer 1) and partly from the medium access control (MAC) (Layer 2). Specifically, layer 1 may include the PHYSICAL Layer, while layer 2 may include MAC, RLC and PDCP. L1/L2 mobility based on L1/L2 signaling may have lower latency, lower overhead, and reduced interruption time.

There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell. The mobility between cells described in these embodiments may be based on the PCell, PSCell, and/or SCell

A user equipment (“UE”) device may move between nodes or cells in which case a handover or a change/addition operation may occur to improve network reliability for the UE as it moves. The movement may be from a source cell to a target cell based on a number of potential target cells that are referred to as candidates. The movement between cells may also include a number of target cells that are potential candidate cells. A conditional handover (“CHO”) and a conditional PSCell addition/change (“CPAC”) are described below. The CPAC may include a conditional PSCell change (“CPC”) and/or a conditional PSCell addition (“CPA”).

A conditional handover (“CHO”) can reduce handover interruption time and improve mobility reliability. A CHO is a handover that is executed by the UE when one or more execution conditions are met. The UE can evaluate the execution condition(s) upon receiving the CHO configuration, and can stop evaluating the execution condition(s) once the handover is triggered. The CHO configuration may include a candidate PCell configuration generated by a candidate target node and the corresponding execution condition(s) for that candidate cell.

A conditional PSCell addition/change (“CPAC”) may include the UE having a network configuration for initiating access to a candidate PSCell, either to consider whether the PSCell is suitable for SN addition or SN change including an intra-SN change. This consideration may be based on configured condition(s). The UE in the wireless network can operate in dual connectivity (“DC”), including intra-E-UTRA DC or Multi-Radio DC (“MR-DC”). In the example of intra-E-UTRA DC, both the MN and SN provide E-UTRA access. While in the example of MR-DC, one node may provide new radio (“NR”) access and the other one provides either E-UTRA or NR access.

To reduce mobility interruption, a Dual Active Protocol Stack (DAPS) based handover procedure may be utilized. In the DAPS based handover procedure, the UE keeps simultaneous connection with the source cell and target cell until releasing the source cell after successful random access to the target cell.

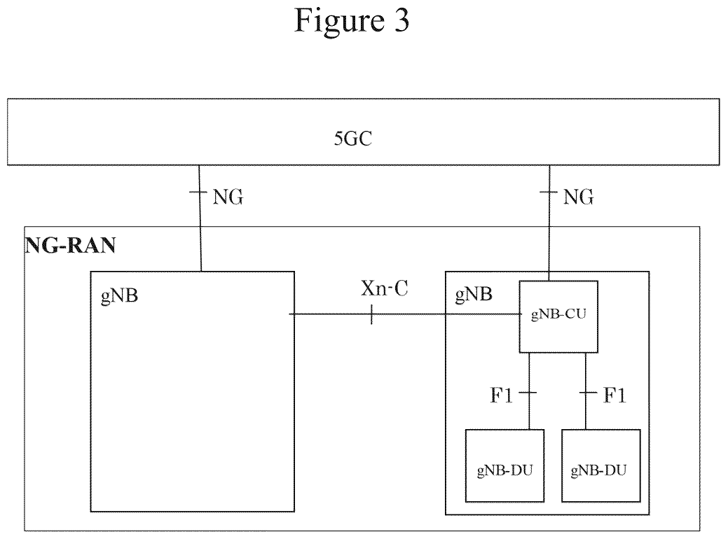

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

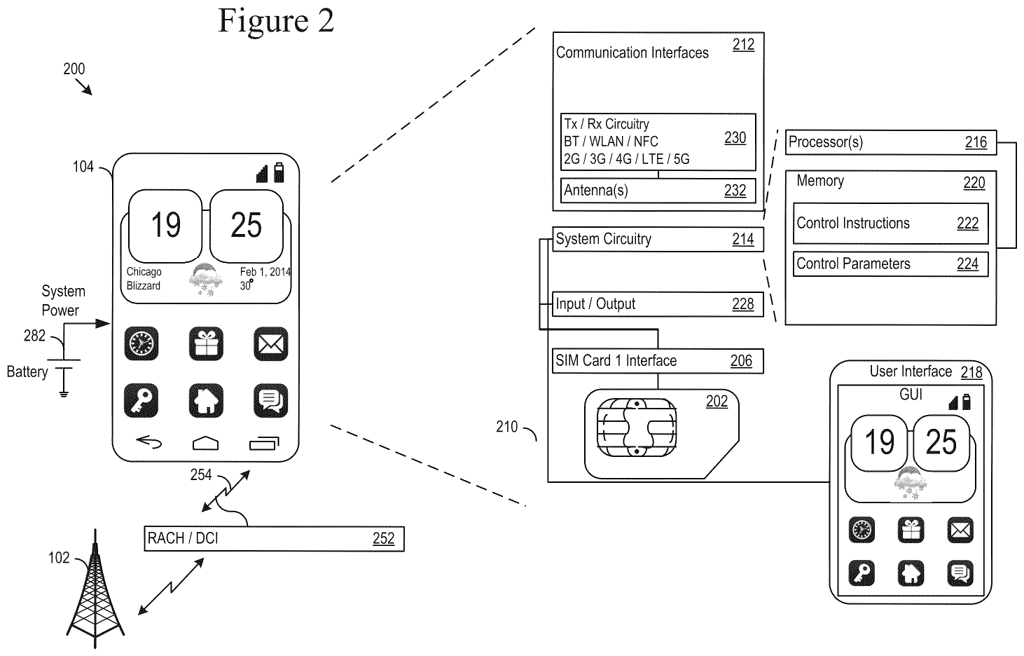

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U(MN) interface instance.

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as have one CU that is connected to two DUs via an F1 interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

### L1/L2 Mobility

The L1/L2 based inter-cell mobility described herein may occur in a number of different examples. For L1/L2 mobility, there may be intra-DU mobility where a UE changes cells within a single DU. Examples of intra-DU mobility include: 1) PCell change within one DU (may also include PCell change with SCell change); 2) PSCell change within one DU (may also include PSCell change with SCell change); and 3) PCell change within one DU with PSCell change within one DU (may also include SCell change within one cell group). In another L1/L2 mobility embodiment, there may be intra-CU and inter-DU mobility where a UE changes cells between different DUs but within a single CU. Examples of intra-CU and inter-DU mobility include: 1) PCell change across DU but within one CU (may also include PCell change with SCell change); and 2) PSCell change across DU but within one CU (may also include PSCell change with SCell change). In another L1/L2 mobility embodiment, there may be inter-CU mobility where a UE changes cells between different CUs. Examples of inter-CU mobility include: 1) PCell change across CU (may also include PCell change with SCell change); and 2) PSCell change across CU (may also include PSCell change with SCell change). In another embodiment, there may be a SCell change/addition and this example may include the SCell addition/change within one cell group. FIGS. 4-6 illustrate embodiments of UE mobility between cells.

FIG. 4 shows an embodiment of user equipment (UE) intra-DU mobility. The basestation may include a CU and at least one DU. In this embodiment, there is a single DU shown that has multiple cells. Both Cell 1 and Cell 2 are from the single DU. In this example, the UE 402 can move from Cell 1 to Cell 2 and is depicted in FIG. 4 with a UE trajectory from Cell 1 to Cell 2. The mobility from cells may occur when the UE 402 is in a position between the two cells and making its way to the third position within Cell 2. This is intra-DU mobility because the UE is moving cells within a single DU.

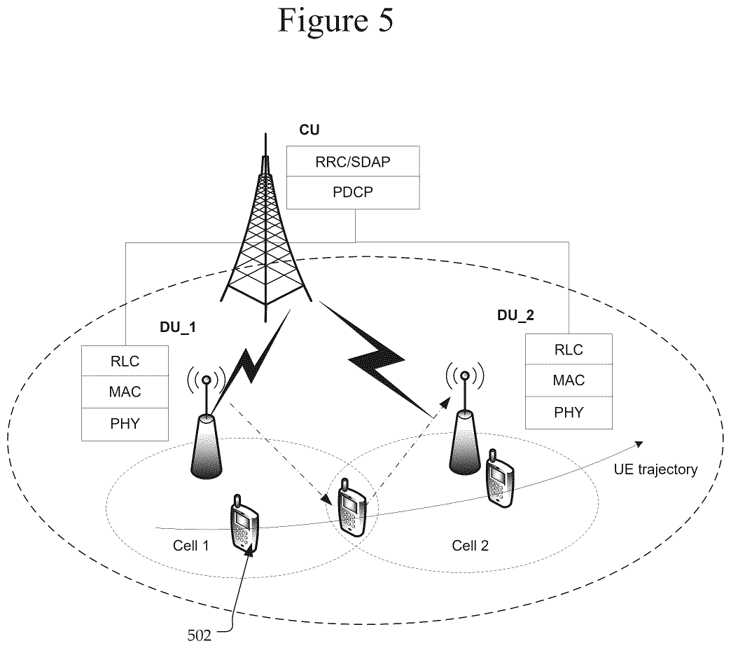

FIG. 5 shows an embodiment of user equipment (UE) intra-CU and inter-DU mobility. In this embodiment, the basestation may include a CU and two DUs (DU_1 and DU_2). Although each DU may have multiple cells, for this example each DU is shown providing a single cell such that DU_1 is providing Cell 1 and DU_2 is providing Cell 2. In this example, the UE 502 can move from Cell 1 to Cell 2 and is depicted in FIG. 5 with a UE trajectory from Cell 1 to Cell 2 which also results in a transition from DU_1 to DU_2. The mobility from cells may occur when the UE 402 is in a position between the two cells and making its way to the third position within Cell 2. This is intra-CU mobility because the UE is moving cells within a single CU. However, this is also inter-DU mobility because the UE is moving between different DUs.

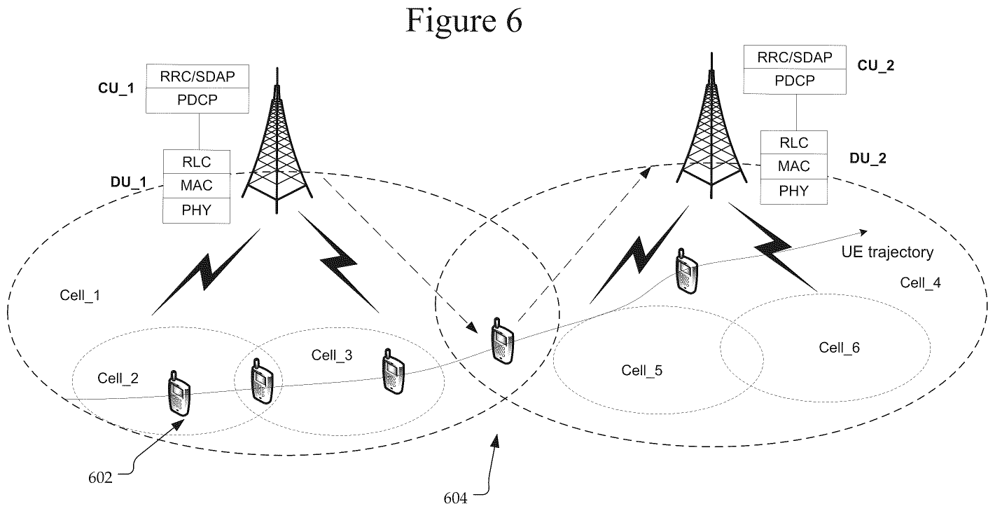

FIG. 6 shows an embodiment of user equipment (UE) inter-CU mobility. In this embodiment, the basestation may include multiple CUs (CU_1 and CU_2). Each CU may include multiple DUs, but in this example, each CU is shown as having one corresponding DU (CU_1 has DU_1 and CU_2 has DU_2). Each of the DUs is shown with multiple cells. In this example, the UE trajectory of the UE 602 passes from Cell_2 to Cell_3 to an inter-CU position 604 (between CU_1 and CU_2) to Cell_5 and Cell_6. As the UE moves, the mobility may change cells as shown and may transition between a number of cells. Because the UE 602 (at the inter-CU position 604) switches cells from CU_1 to CU_2, this transition is referred to as inter-CU mobility.

### L1/L2 Triggered Mobility (LTM)

The mobility between cells can be triggered by the L1/L2 signaling for improved mobility between cells. L1/L2 mobility enhancements can provide a serving cell change via L1/L2 signaling with such lower latency, lower overhead and lower interruption time. The examples described throughout may be procedures and signaling of LTM.

In the following discussion, a candidate cell may be referred to as a candidate cell group (CG), or a candidate CG may be referred to as a candidate cell. The candidate CG may be referred to as candidate MCG or candidate SCG. The candidate cell may be referred to as candidate PCell in candidate MCG, or candidate PSCell in candidate SCG.

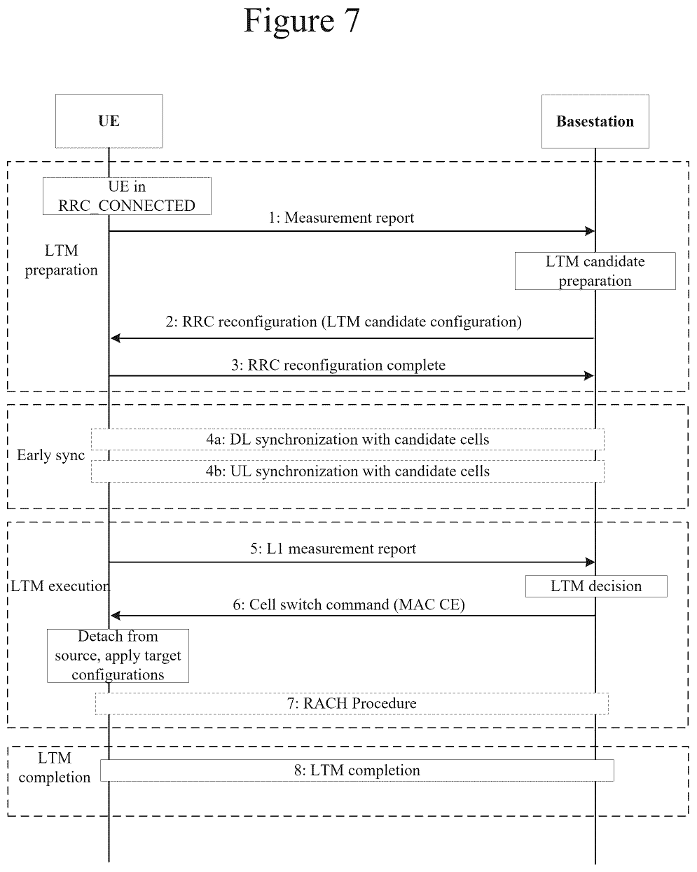

FIG. 7 shows an embodiment of a signaling procedure for L1/L2 triggered mobility (LTM). L1/L2 triggered mobility (LTM) may include a procedure in which a basestation receives L1 measurement reports from UEs, and uses them to change a UEs' serving cell(s) through L1/L2 signaling (e.g. MAC CE, DCI). The basestation prepares one or multiple candidate cells and provides the candidate cell configurations to the UE through RRC message. Then the LTM cell switch is triggered, by selecting one of the candidate configurations as target configuration for LTM by the basestation. The overall procedure for LTM is shown in FIG. 7. Subsequent LTM can be done by repeating the early synchronization, LTM execution, and LTM completion steps without releasing other candidates after each LTM completion. As illustrated, there may be four main parts in one embodiment: 1) LTM preparation; 2) early synchronization; 3) LTM execution; and LTM completion.

The procedure shown in FIG. 7 for LTM may include:

1. The UE sends a MeasurementReport message to the basestation. The basestation decides to use LTM and initiates LTM candidate preparation.

2. The basestation transmits an RRCReconfiguration message to the UE including the configuration of one or multiple LTM candidate target cells.

3. The UE stores the configuration of LTM candidate target cell(s) and transmits a RRCReconfigurationComplete message to the basestation.

4a/b. The UE may perform DL synchronization or/and UL synchronization (i.e. TA acquisition) with candidate target cell(s) before receiving the LTM cell switch command.

5. The UE performs L1 measurements on the configured LTM candidate target cell(s), and transmits lower-layer measurement reports to the basestation. The order of step 4a/b and step 5 may be modified to be in a different order. The UE may perform L1 measurements before performing DL synchronization or/and UL synchronization.

6. The basestation decides to execute LTM cell switch to a target cell, and transmits a MAC CE triggering LTM cell switch by including the candidate configuration index of the target cell. The UE switches to the configuration of the LTM candidate target cell.

7. The UE performs random access procedure towards the target cell, if TA is not available.

8. The UE indicates successful completion of the LTM cell switch towards target cell.

### Candidate Cell/Cell Group Configuration

The NW configures and provides one or multiple LTM candidate cell configuration via RRC message, e.g. RRCReconfiguration message.

The candidate cell configuration (i.e. RRC model of the candidate cell configuration) can be configured with different options:
Option 1: One RRCReconfiguration message for each candidate configuration; and
Option 2: One or multiple IEs for each candidate configuration. The IEs may include at least one of the following: RRCReconfiguration IEs, CellGroupConfig IEs, RadioBearerConfig IEs, MeasConfig IEs, etc.

For option 2, the signaling structure may include at least one of:
Option 2a: have a general LTM candidate configuration list (e.g. ltm-CandidateToAddModList, ltm-CandidateToRemoveList). Each LTM candidate configuration includes candidate configuration index, CellGroupConfig IE and other possible/optional configured IEs, e.g. RadioBearerConfig, MeasConfig.
Option 2b: There may be separate LTM candidate part lists for each possible IEs (e.g. a candidate CellGroupConfig ToAddMod/ToRelease list, a candidate RadioBearerConfig ToAddMod/ToRelease list, a candidate MeasConfig ToAddMod/ToRelease list, and add some mapping/link among them to have a complete LTM candidate configuration).

In Option 2b, considering that some candidate cells may share the common radio bearer configuration (e.g. for intra-DU candidates) and/or measurement configuration (e.g. for intra-frequency candidates), separate radio bearer configuration lists and measurement configuration lists can allow the candidate cell to refer to the required configuration part from the separate list.

The candidate cell configuration (e.g. CellGroupConfig) may be linked with other possible configurations (e.g. RadioBearerConfig, MeasConfig) according to several options:
Alt. 1: For each candidate cell configuration, it may include a candidate cell configuration index, a candidate cell group level configuration (e.g. a CellGroupConfig IE), one or more reference index(s) to refer to other IE configuration(s) from separate reference configuration list(s)/pool(s) (e.g. a candidate radio bearer configuration index to refer to the indicated radio bearer configuration from the candidate radio bearer configuration list, a candidate measurement configuration index to refer to the indicated measurement configuration from the candidate measurement configuration list, etc).
Alt. 2: In a reference configuration list, for each reference configuration, there may be links with one or more candidate cell index(s) to indicate that configuration can be used by the associated candidate cell. For example, in a candidate radio bearer configuration list, for each candidate radio bearer configuration, it may link with one or more candidate cell index(s) to indicate that configuration can be used by the associated candidate cell(s). The similar structure may also be applicable to candidate measurement configuration list.

An example of ASN.1 structure for LTM candidate configuration (i.e. for option 2b above) includes:

```
RRCReconfiguration message
RRCReconfiguration-Ies ::= SEQUENCE {
  radioBearerConfig RadioBearerConfig
OPTIONAL, -- Need M
  masterCellGroup OCTET STRING (CONTAINING CellGroupConfig)
OPTIONAL, -- Cond SCG
  measConfig MeasConfig
OPTIONAL, -- Need M
  lateNonCriticalExtension OCTET STRING
OPTIONAL,
  nonCriticalExtension RRCReconfiguration-v1530-Ies
OPTIONAL
}
RRCReconfiguration-vXXXX-Ies ::= SEQUENCE {
  ltm-CandidatesConfig-r18 SetupRelease {LTM-CandidatesConfig-r18}
OPTIONAL, -- Need M
  lateNonCriticalExtension OCTET STRING
OPTIONAL,
  nonCriticalExtension SEQUENCE { }
OPTIONAL
}
LTM-CandidatesConfig information element
LTM-CandidatesConfig-r18 ::= SEQUENCE {
  ltm-CandidateToRemoveList-r18 LTM-CandidateToRemoveList-r18
OPTIONAL, -- Need N
  ltm-CandidateToAddModList-r18 LTM-CandidateToAddModList-r18
OPTIONAL, -- Need N
  ltm-CandRadioBearerConfigToRemoveList-r18 LTM-CandRadioBearerConfigToRemoveList-r18
OPTIONAL, -- Need N
  ltm-CandRadioBearerConfigToAddModList-r18 LTM-CandRadioBearerConfigToAddModList-r18
OPTIONAL, -- Need N
  ltm-CandMeasConfigToRemoveList-r18 LTM-CandRMeasConfigToRemoveList-r18
OPTIONAL, -- Need N
  ltm-CandMeasConfigToAddModList-r18 LTM-CandMeasConfigToAddModList-r18
OPTIONAL, -- Need N
  ...
}
LTM-CandidateToReleaseList-r18 ::= SEQUENCE (SIZE (1..maxNrofCellsLTM-r18)) OF LTM-CandidateId-r18
OPTIONAL, -- Need N
LTM-CandRadioBearerConfigToReleaseList-r18 ::= SEQUENCE (SIZE (1..maxNrofCellsLTM-r18)) OF LTM-
CandRadioBearerConfigId-r18 OPTIONAL, -- Need N
LTM-CandMeasConfigToReleaseList-r18 ::= SEQUENCE (SIZE (1..maxNrofCellsLTM-r18)) OF LTM-
CandMeasConfigId-r18 OPTIONAL, -- Need N
LTM-CandidateToAddModList-r18 ::= SEQUENCE (SIZE (1..maxNrofCellsLTM-r18)) OF LTM-
CandidateToAddMod-r18
LTM-CandRadioBearerConfigToAddModList-r18 ::= SEQUENCE (SIZE (1..maxNrofCellsLTM-r18)) OF LTM-
CandRadioBearerConfigToAddMod-r18
LTM-CandMeasConfigToAddModList-r18 ::= SEQUENCE (SIZE (1..maxNrofCellsLTM-r18)) OF LTM-
CandMeasConfigToAddMod-r 18
LTM-CandidateToAddMod-r18 ::= SEQUENCE {
  ltm-CandidateId-r18 LTM-CandidateId-r18,
  ltm-CellGroupConfig-r18 OCTET STRING (CONTAINING CellGroupConfig),
  ltm-RadioBearerConfig-r18 LTM-CandRadioBearerConfigId-r18
OPTIONAL,
  ltm-Meas Config-r18 LTM-CandMeasConfigId-r18
OPTIONAL,
  ...
}
LTM-CandRadioBearerConfigToAddMod-r18 ::= SEQUENCE {
ltm-CandRadioBearerConfigId-r18 LTM-CandRadioBearerConfigId-r18,
ltm-CanRadioBearerConfig-r18 RadioBearerConfig
  ...
}
LTM-CandMeasConfigToAddMod-r18 ::= SEQUENCE {
  ltm-CandMeasConfigId-r18 LTM-CandMeasConfigId-r18,
  ltm-CanMeasConfig-r18 MeasConfig
  ...
}
```

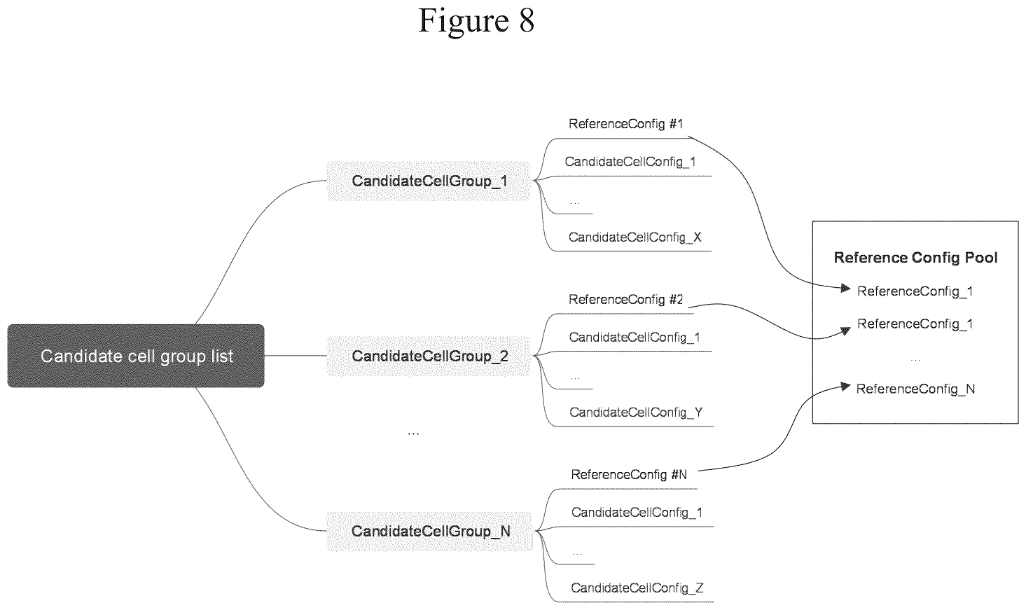

FIG. 8 shows one embodiment of a candidate cell group list structure. FIG. 8 illustrates one example signaling structure that may be used for signaling optimization. The network/basestation can configure several candidate cell groups (e.g. a candidateCellGroupList). Each candidate cell group includes one or multiple candidate target cell configuration. The candidate cells included in one candidate cell group may share some common configuration (e.g. refer to the same reference configuration). Different candidate cell groups can may be associated with different reference configurations. For each candidate cell there may be groups of configurations. Each candidate cell group (CCG) may include different candidate cell configurations. The reference configurations can be configured in a separate reference configuration pool. Each reference configuration can be referred to from the candidate cell group (e.g. by indicating the reference configuration index).

During cell switch, when the UE resets a cell switch command, the UE may need to reset L2 handling. For one example CCG structure, the UE may be different from the CCG reference/structure. The network/basestation can configure all candidate cells belonging to one DU into one candidate cell group (CCG). In this example, the cell switch between candidate cells belonging to one candidate cell group (i.e. intra-group cell switch) is intra-DU LTM (i.e. the UE is not required to perform L2 reset upon triggering cell switch). The cell switch between candidate cells belonging to different candidate cell groups (i.e. inter-group cell switch) is inter-DU LTM (i.e. the UE is required to perform L2 reset upon triggering cell switch). Accordingly, the cell switch command can indicate the candidate cell group ID and the candidate cell configuration ID, to help the UE distinguish the intra-DU LTM and inter-DU LTM.

The network/basestation can also configure candidate cells belonging to one DU into different candidate cell groups (CCGs). The candidate cells belonging to one cell group must belong to one DU. In this example, the intra-group cell switch is intra-DU LTM. Inter-group cell switch may be intra-DU or inter-DU LTM. Thus, the network/basestation can additionally indicate whether the cell switch is intra-DU or inter-DU in the cell switch command when the cell switch is inter-group cell switch. The cell switch command may include at least one of the following information
the candidate cell group ID/index;
the candidate cell configuration ID/index; or
an indication to indicate whether the cell switch is intra-DU or inter-DU cell switch

If the received candidate cell group ID/index is the same as the CCG ID/index that refers to the CCG including the candidate cell configuration currently applied by the UE, the UE may consider the cell switch to be an intra-DU cell switch. Otherwise, the UE may consider the cell switch to be an inter-DU cell switch. For intra-DU cell switch, the UE may not perform the L2 reset or may perform the partial L2 reset (e.g. partial MAC reset) during the cell switch. For inter-DU cell switch, the UE may perform the L2 reset during the cell switch. The L2 reset may include MAC reset, RLC re-establishment, and/or PDCP data recovery.

For each LTM candidate cell configuration, it may be configured with delta configuration, reference configuration and/or reference index. The reference index may be used to indicate the cell configuration that the UE can use as the baseline/template/reference for the LTM candidate cell configuration. The LTM candidate cell configuration may include at least one of:
the candidate cell configuration index;
cell group configuration, e.g. CellGroupConfig IE;
a reference index (e.g. reference cell group config ID) to refer to the indicated cell group level configuration from the candidate cell group level configuration list;
radio bearer configuration, e.g. RadioBearerConfig IE;
a reference index (e.g. reference radio bearer config ID) to refer to the indicated radio bearer configuration from the candidate radio bearer configuration list;
RRM measurement configuration, e.g. MeasConfig IE;
a reference index (e.g. reference meas config ID) to refer to the indicated RRM measurement configuration from the candidate measurement configuration list;
a reference index (e.g. reference cell ID) to refer to the indicated candidate cell configuration from the candidate cell list.

For each IE in the LTM candidate cell configuration, it may also be configured with delta configuration or reference index.

For some dedicated/specific configurations of the candidate cell (e.g. TA/TAG configuration, CFRA resources configuration, BWP configuration, or C-RNTI) the network/basestation may configure some common configuration pools for possible resources/configurations required by all serving cells and candidate cells. The association of the candidate cell with the dedicated/specific configuration may include the following options:

Option 1: A separate list can be configured by the network/basestation to associate the candidate cell with the dedicated/specific configuration (e.g. a configuration index linked with a candidate cell index).

Option 2: The association between the specific resource/configuration with the candidate cell can be indicated in the candidate cell configuration (i.e. via RRC message) (e.g. including a configuration index in the candidate cell configuration).

Option 3: The association between the specific resource/configuration with the candidate cell can be indicated (or dynamically indicated) by the cell switch command (e.g. including a configuration index in the cell switch command).

The reference configuration can be defined to reduce the overhead for each candidate cell. Each candidate cell may have multiple part configurations to generate the complete/full configuration. Handover (HO) may use source configuration for baseline and reconfiguration of the different part for the candidate cell is used to improve performance. Delta configuration may be the different/other part of the reference configuration. The LTM candidate cell configuration can be configured with the delta configuration. The delta configuration is generated based on the reference configuration. The reference configuration definition may be with the following options:
Option 1: The reference configuration is explicitly configured by the NW (i.e. a separate reference configuration).
Option 1-1: Specify/indicate one of the candidate cells as the reference configuration (e.g. the network/basestation indicates the reference cell index within each candidate cell configuration).
Option 1-2: Define one reference configuration independent from the candidate cell configuration.
Option 2: The reference configuration is the UE configuration when the candidate cell configuration is received, i.e. the initial source configuration.
Option 3: The reference configuration is the UE configuration when the cell switch command is received. In one example, the network/basestation provides cells 1,2,3 then the UE maintains configuration for each so does not need to provide the update for each candidate configuration, which is based on the pre-configurations.
Option 3-1: For each candidate cell, the network/basestation pre-configures several candidate delta configurations, each one is configured based on possible source cell (e.g. the initial source cell, other candidate cells).
Option 3-2: Upon reception of the candidate cell configuration, for each candidate cell, the UE translates the received the candidate cell configuration and generates a set of delta configuration based on possible source cell.

For option 1, the reference configuration may be configured: 1) a full set of cell configuration, e.g. containing RRCReconfiguration message; 2) a set/pool of common configuration among multiple cells (e.g. a set/pool of RS across source and candidate cells); or 3) several sets of reference configuration for different configuration part (e.g. a set of reference cell group configuration, a set of reference radio bearer configuration, or a set of reference measurement configuration).

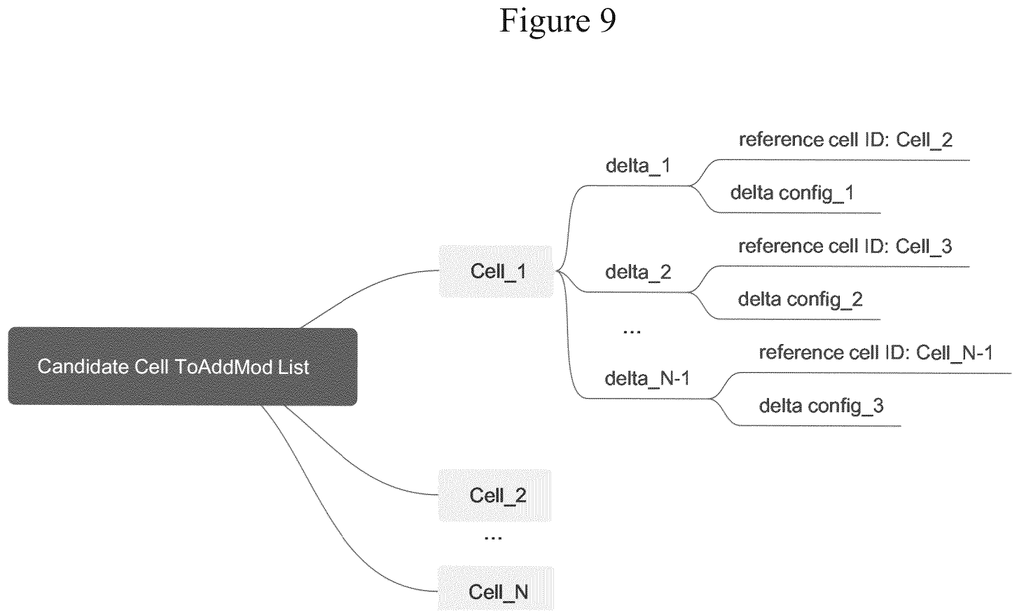

FIG. 9 shows one embodiment of a candidate cell signaling structure. Specifically, FIG. 9 may apply to Option 3 above. For each candidate cell, there may be a set of delta configurations, where each delta configuration is linked with a reference cell ID (e.g. other candidate cell index). If the reference cell ID is absent, it may imply that the delta configuration is generated based on the initial source configuration. For an inter-DU example, each candidate DU may need to know candidate cell configurations (e.g. the full configuration or the delta configuration based on the initial source configuration) generated by other candidate DUs. This procedure may introduce additional and complex interaction between the CU and candidate DU.

The UE behavior upon reception of the reference and/or candidate cell configuration may include the UE storing the reference configuration and candidate cell configuration separately in different variables (e.g. storing the reference configuration as a separate configuration, such as a store of the reference configuration into the VarReferenceConfig). If the reference configuration is the initial source configuration, the UE may store the source configuration as a separate configuration upon reception of the candidate cell configurations or after completion of the initial/first LTM execution (e.g. switching from the initial source cell to a candidate cell). In an alternative example, the UE translates each delta configuration into a full configuration, and stores the full configuration for each candidate cell.

For options 1 and option 2, upon triggering the LTM execution (e.g. reception of cell switch command), the UE may first restore or revert back to the reference configuration, and then apply the delta configuration of the target candidate cell, based on the reference configuration. During this procedure, the UE may need to release and add back some RLC bearers. For example, the reference configuration includes two RLC bearers, the candidate cell #1 has two RLC bearers (e.g. RLC bearer 1, RLC bearer 2), the candidate cell #2 and cell #3 have three RLC bearers (e.g. RLC bearer 1, RLC bearer 2, RLC bearer 3). For the first cell switch from cell #1 to cell #2, the UE needs to add the third RLC bearer for the cell #2 configuration, based on the reference configuration. For the second cell switch from cell #2 to cell #3, the UE firstly needs to fall back to the reference configuration, which requires to release the RLC bearer 3. Then the UE applies the delta configuration for cell #3 based on the reference configuration, which requires to add RLC bearer 3 again. The release and add RLC bearer operation has an effect similar to reestablishRLC (e.g. the UE shall discard all RLC SDUs, RLC SDU segments, and RLC PDUs, if any), and resets all state variables to their initial values. A similar issue may apply to the SCell release and add, e.g. for sCellToAddModList.

In order to avoid an unnecessary release and add issue, there may be several possible solutions:
Alt. 1: the reference configuration includes all possible RLC bearers and/or SCells across all candidate cells.
Alt. 2: upon reception of the cell switch command, the UE stores RLC states variables and the data stored in transmission and reception buffers in RLC entities, and then reverts back to the reference configuration. After applying the delta configuration based on the reference configuration, the UE restores the corresponding RLC states variables and data in transmission and reception buffers for each established RLC entities.
Alt. 3: the network/basestation shall not re-configure RLC bearer for LTM, i.e. the RLC bearer is not allowed to add, modify or release for LTM candidate cell configuration.

For option 3, upon triggering the LTM execution (e.g. reception of cell switch command), the UE may directly apply the delta configuration for the target candidate cell, which is based on the current source cell, e.g. applying the delta configuration linked with the reference index to refer to the current source cell.

### L1 Measurement Configuration

For the L1 measurement configuration, the UE needs to perform L1 measurements for each candidate cell. The network/basestation provides L1 measurement information for each candidate cell configuration. There may be inter-cell beam management (ICBM) that has supported performance of SSB based L1 measurement on non-serving cell beams by configuring the L1 SSB measurement resources of non-serving cells in the ServingCellConfig and associating TCI-states with AdditionalPCIs (i.e. non-serving cell PCI). Rel-17 ICBM may be applicable to intra-DU intra-frequency example. In order to support inter-cell L1 measurement for LTM candidate cells, some enhancements may be considered.

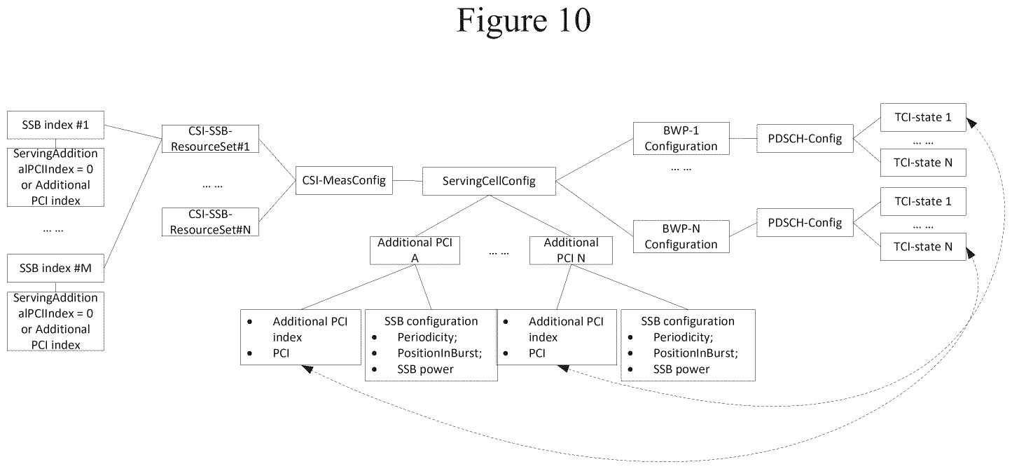

FIG. 10 shows one embodiment of a signaling structure for L1 measurement configuration. The L1 measurement resources for the non-serving cell (i.e. the additional PCI information and associated SSB configuration, in additionalPCI-ToAddModList) may be configured under the ServingCellConfig. The TCI-state may be linked with the non-serving cell, by indicating additional PCI index configured by additionalPCI-ToAddModList in ServingCellConfig. In CSI-MeasConfig, the CSI-SSB resource for non-serving cell is indicated by the servingAdditionalPCIList-r17 within the CSI-SSB-ResourceSet in csi-SSB-ResourceSetToAddModList. There may be additional PCI information indicating a PCI index, and/or SSB configuration.

For the L1 measurement framework, there may be several options:

Option 1: reuse R17 ICBM framework (e.g. FIG. 10), i.e. the L1 RS resources for serving can candidate cells are explicitly indicated in the source cell configuration. In this example, candidate DUs and source DUs may need to perform some interaction via the CU. The CSI measurement configuration indicates explicitly the RS indices that shall be measured by the UE for serving and candidate cells. The candidate DU provides the configuration of candidate cells RS to the source DU via the CU. The source DU re-configures or updates the L1 measurement configuration of serving cell (e.g. CSI-MeasConfig), to provides the L1 RS resources for serving cells and candidate cells, and the L1 report configuration, etc.

Option 2: the L1 RS resources for each candidate cell is included in each candidate cell configuration. In this example, the UE needs to decode and/or apply the L1 measurement configuration included in each candidate cell configuration before cell switch (e.g. upon reception the LTM candidate cell configuration) to perform the L1 measurement for candidate cells.

Option 3: the L1 RS resources and/or TCI states for serving and candidate cells are configured in a separate set of configuration, e.g. a common L1 measurement pool is used to configure the L1 measurement configurations and/or TCI states for serving and candidate cells. The TCI states can be used to provide/configure the association between RS/beam and cell. This may be similar to the reference configuration discussed above. Reference candidate are collected for being referred to by a resource index or reference index. The common L1 measurement pool can be generated by the CU or the DU. The common L1 measurement pool configuration is always maintained. It can be updated or released via RRC reconfiguration message. The network/basestation may explicitly indicate/configure which candidate cells/RSs to be measured for LTM triggering (e.g. via CSI-MeasConfig). The network/basestation may not explicitly indicate/configure which candidate cells/RSs to be measured for LTM triggering. It may be up to the UE to measure and report e.g., strongest RS indices for the serving and target cells. The network/basestation may dynamically indicate/active which candidate cells/RSs to be measured for LTM triggering, indicating the candidate cell index(s), beam/RS index(s) and/or TCI-state(s) via L1/L2 signaling.

The L1 measurement RS resource configuration may be used to avoid repeated RS resource configuration among candidate cells and reduce signaling overhead. The L1 measurement resource set configuration (e.g. SSB, CSI-RS resources configuration) may be decoupled with the serving cell configuration, i.e. to define a set/pool of RS resource configuration. The RS resource configuration set/pool can be configured under RRCReconfiguration message, CellGroupConfig IE or ServingCellConfig IE. The RS resource configuration set/pool may include RS resources (e.g. SSB, CSI-RS) configuration to be measured by serving cells and/or candidate cells. The RS resources configuration (e.g. similar to CSI-ResourceConfig) may include at least one of 1) SSB resource configuration; 2) SSB resource set configuration; 3) CSI-RS resource configuration; or 4) CSI-RS resource set configuration, each of which is discussed below.

The SSB resource configuration may include at least one of:
SSB configuration index
Periodicity of the SS/PBCH blocks, e.g. periodicity
A bit map to indicate the time domain positions of the transmitted SS-blocks in a half frame with SS/PBCH blocks, e.g. ssb-PositionsInBurst
Average EPRE of the resources elements that carry secondary synchronization signals in dBm that the network/basestation used for SSB transmission, e.g. ss-PBCH-BlockPower
Measurement timing configurations (i.e., timing occasions at which the UE measures SSBs), e.g. SSB-MTC
Frequency of the SSB

The SSB resource set configuration, may include at least one of:
SSB resource set configuration index;
A list of SSB index to indicate the SSB to be measured;
A list of PCI of the associated SSBs;
Measurement timing configurations (i.e., timing occasions at which the UE measures SSBs), e.g. SSB-MTC; or
Frequency of the SSB.

The CSI-RS resource configuration, may include at least one of:
CSI-RS configuration index;
NZP CSI-RS resource configuration (e.g. including Periodicity and slot offset for the CSI-RS, Power offset of RE, a reference to TCI-State, OFDM symbol location(s) in a slot and subcarrier occupancy in a PRB of the CSI-RS resource, Scrambling ID);
CSI-IM resource configuration (e.g. including the resource element pattern); or
Frequency of the CSI-RS.

The CSI-RS resource set configuration, may include at least one of:
CSI-RS resource set configuration index;
A list of CSI-RS resource index to indicate the CSI-RS to be measured;
Frequency of the CSI-RS; or
Other set-specific parameters . . . .

An information list may be generated to indicate which L1 resource configurations are associated with which candidate cells. The information list may comprise a additional/candidate cell info list. The additional/candidate cell info list (e.g. additionalPCI-ToAddModList, candidateCellToMeas-ToAddModList, TCI-state list) may be configured to link the RS resource configuration(s), beam information(s) or TCI-state(s) with different cells (e.g. including serving cells, non-serving cells and/or candidate cells). The RS resource, beam information or TCI state is configured for uplink (UL) transmission only, downlink (DL) transmission only, or both UL and DL transmission. There may be an additional/candidate cell info list for UL transmission only, a additional/candidate cell info list for DL transmission only, or/and a additional/candidate cell info list for both UL and DL transmission. Each item in the information list may include at least one of the following:
cell identification information, e.g. PCI, candidate cell ID/index, serving cell ID/index, candidate cell configuration ID/index;
RS resource configuration index, e.g. to refer to the RS configuration (e.g. CSI-RS, SSB) in the RS resource configuration set/pool;
SSB configuration index, e.g. to refer to the SSB configuration in the RS resource configuration set/pool;
SSB resource set configuration index, e.g. to refer to the SSB resource set configuration in the RS resource configuration set/pool
CSI-RS configuration index, e.g. to refer to the CSI-RS configuration in the RS resource configuration set/pool; or
CSI-RS resource set configuration index, e.g. to refer to the CSI-RS resource set configuration in the RS resource configuration set/pool.

For each candidate cell/DU, an additional/candidate cell info list may be configured by the network/basestation (e.g. CU or DU). The additional/candidate cell info list above may be configured under RRCReconfiguration message, CellGroupConfig IE and/or ServingCellConfig IE. The additional/candidate cell info list may be combined with a candidate cell configuration list or be configured within a candidate cell configuration. A TCI-state list may be configured to link the TCI-state with the cell in the additional/candidate cell list, to indicate which cell's RS signal configured as the QCL source of the associated TCI-state.

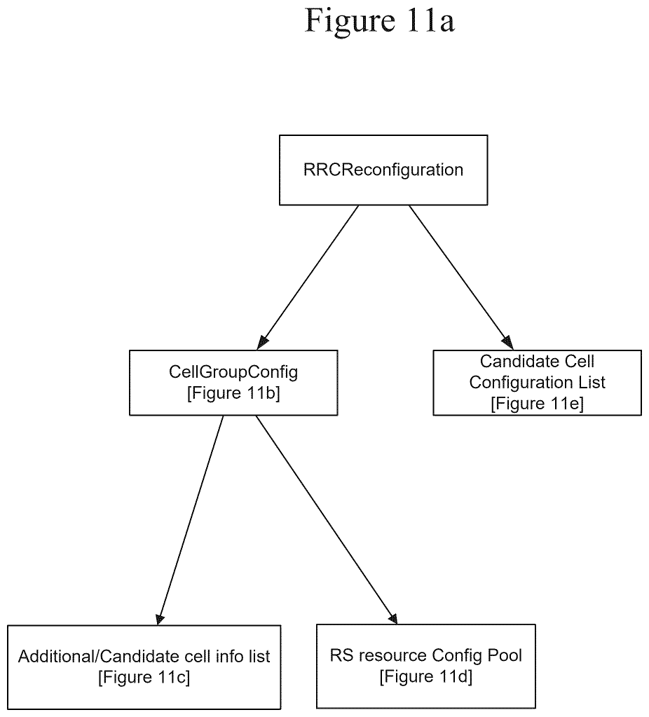

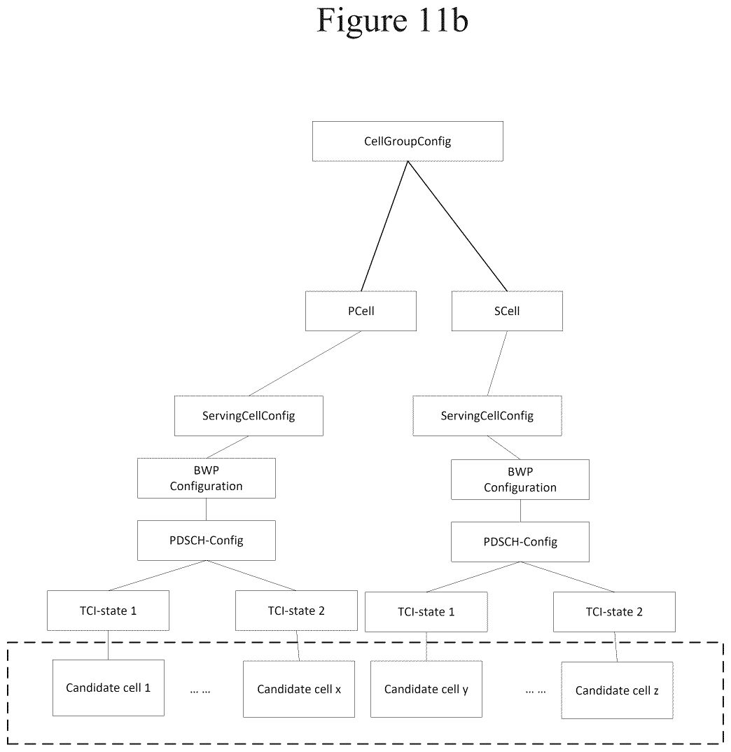

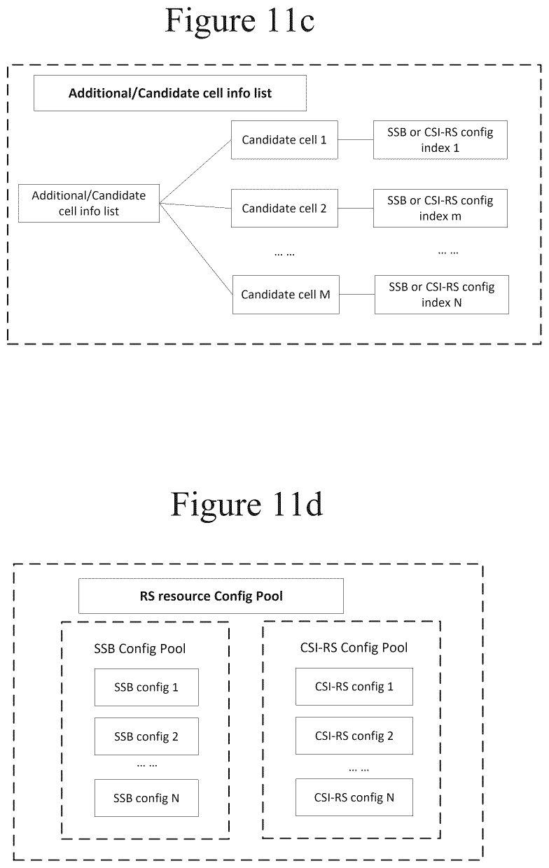

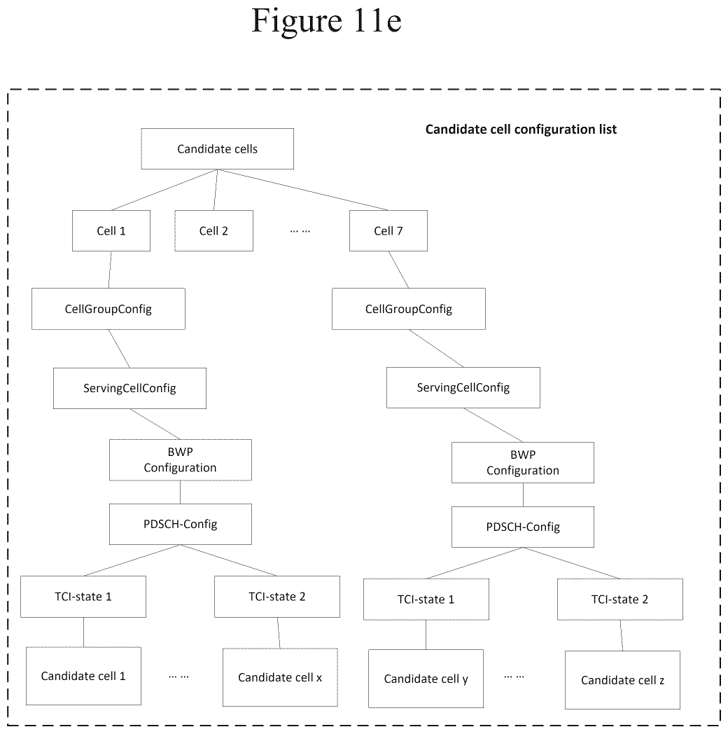

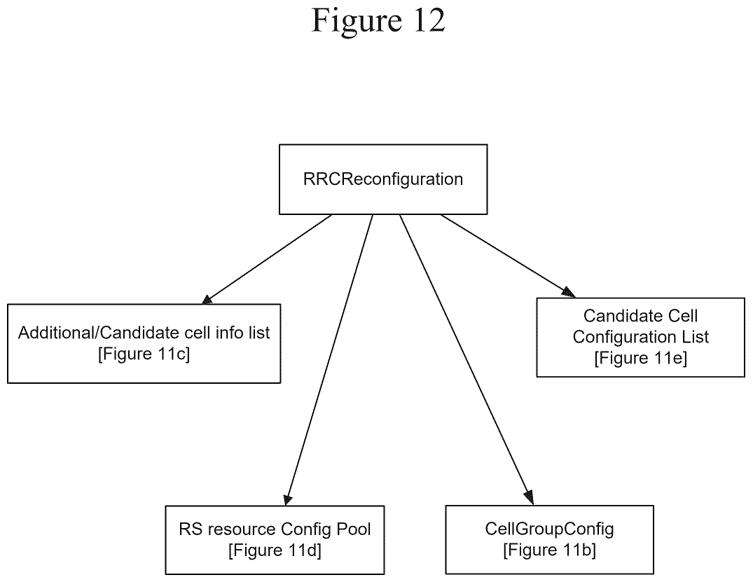

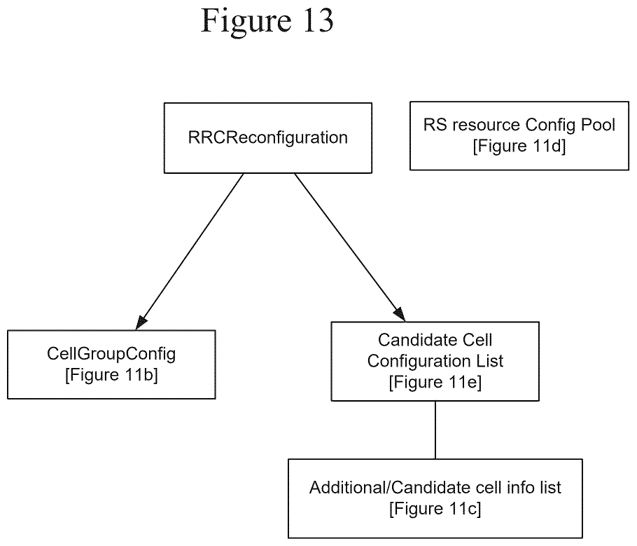

Based on the embodiments above, possible signaling structures for R18 L1 measurement resource configuration may include:
Alt. 1: the RS resource configuration pool and/or the additional/candidate cell info list are configured under the ServingCellConfig (i.e. the current structure).
Alt. 2: the RS resource configuration pool and/or the additional/candidate cell info list are configured under the CellGroupConfig. FIG. 11a shows a first embodiment of a configuration signaling structure. FIGS. 11b-11e show the remaining structure of the configuration signaling structure. FIG. 11b shows an example cell group configuration from FIG. 11a. FIG. 11c shows an example cell information list from FIG. 11a. FIG. 11d shows an example resource configuration pool from FIG. 11a. FIG. 11e shows an example candidate cell configuration list from FIG. 11a.
Alt. 3: the RS resource configuration pool and/or the additional/candidate cell list are configured under the RRCReconfiguration message, i.e. parallel from CellGroupConfig. FIG. 12 shows a second embodiment of a configuration signaling structure.
Alt. 4: the additional/candidate cell info list is combined with candidate cell configuration list, e.g. for each candidate cell, the RS configuration (by referring to RS configuration indexes) is directly configured with candidate cell configuration. FIG. 13 shows a third embodiment of a configuration signaling structure. The RS resource configuration pool can be configured under the CellGroupConfig of the source cell, or under the RRCReconfiguration message.

The L1 measurement report configuration may be provided by CSI-ReportConfig in CSI-MeasConfig within ServingCellConfig, e.g. configured per cell. In CSI-ReportConfig, CSI-ResourceConfigId and ServCellIndex may also be referred to indicate in which cell the indicated CSI-ResourceConfig are to be found. The source cell needs to know RS resource configuration generated by each candidate cell/DU to generate the report configuration (e.g. report type, report resources) for the L1 measurement report for such candidate cells. If the legacy L1 measurement mechanism is reused, in each source serving cell, there is a need to configure which cell's RS resources can be measured and reported, which may cause complicated and heavy signaling structure. One embodiment may allow reuse of the L3 measurement mechanism (e.g. the UE may measure all configured L1 RS resources, but report the strongest RS indexes).

The Report mechanism may include:
Option 1: the network/basestation explicitly configures/indicates in which cell the RS resources can be measured and/or in which cell the L1 report can be sent, e.g. reuse CSI measurement mechanism. The UE measures the L1 RS and performs L1 measurement report based on the network/basestation configuration.
Option 2: the L1 RS resources are not explicitly configured/indicated for each cell. The UE may measure all configured L1 RS resources, but report the strongest RS indexes, or the strongest RS indexes and the associated cell IDs, e.g. L3-similar measurement mechanism.

The Report configuration may include at least one of the following information:
The trigger events, e.g. the L1 measurements of candidate cells becomes better than the network/basestation configured threshold value, the number of the L1 measurements of candidate cells better than the network/basestation configured threshold value is higher than the network/basestation configured number.
The maximum number of RS/beams and/or cells can be reported in one L1 measurement report.

The Report format may be UCI (e.g. CSI report) or may be MAC CE. The L1 measurement report content may include at least one of:
Cell ID information, e.g. PCI, PCI+frequency, candidate cell configuration index, serving cell ID.
RS/beam ID, e.g. RS/beam resource configuration index, SSB index, CSI-RS index, each RS ID may be associated with a cell ID.
Additional/candidate cell info index, e.g. TCI-state ID, used to indicate the association between RS/beam and cell.
L1 measurement ID, used to link the RS resources with the report Config
L1 measurement results, e.g. L1-RSRP, L1-RSRQ, and/or L1-SINR.
An indication to indicate whether the UL synchronization is available/complete for the associated candidate cell and/or candidate RS/beam(s).
An indication to indicate whether the TA is available/obtained for the associated candidate cell and/or candidate RS/beam(s).

For signaling optimization, a separate set/pool of report configuration can be configured, e.g. similar to the RS resource configuration. For each report configuration, it may include at least one of the follows: report configuration index, report type, report quantity, report resources, etc. If the report is sent on PUSCH (e.g. semi-persistent or aperiodic report sent on PUSCH triggered by DCI, or report conveyed by MAC CE), then there may be no need to configured PUCCH report resources in the report configuration.

A separate L1 measurement association list (e.g. measurement ID list) may be configured to link the RS resource configuration with the report configuration. For example, the L1 measurement ID list can include:
Alt. 1: the RS resource configuration ID and the report configuration ID, i.e. not to indicate in which cell the RS resources are to be found, and in which cell the report is to be sent.
Alt. 2: the RS resource configuration ID, the cell ID that the RS resources to be found, and the report configuration ID.
Alt. 3: the RS resource configuration ID, the cell ID that the RS resources to be found, the report configuration ID, and the cell ID the report is to be sent.
Alt. 4: additional/candidate cell info index (e.g. TCI-state ID) and the report configuration ID.

In some embodiments, the RS resource configuration ID and the cell ID that the RS resources are to be found may be combined into one index (e.g. the additional/candidate cell info index discussed above). In some embodiments, the report configuration ID and the cell ID that the report is to be sent, are combined into one index. The report configuration set/pool may be configured under RRCReconfiguration message, CellGroupConfig IE or ServingCellConfig IE. The L1 measurement association list can be configured under RRCReconfiguration message, CellGroupConfig IE or ServingCellConfig IE.

In some embodiments, there is a reference configuration for L1 measurement. The RS resource configuration pool, the additional/candidate cell info list, the report configuration set/pool and/or the L1 measurement association list can be considered as components of the reference configuration. The candidate cell can refer to the index from such pool/list to configure the L1 measurement configuration.

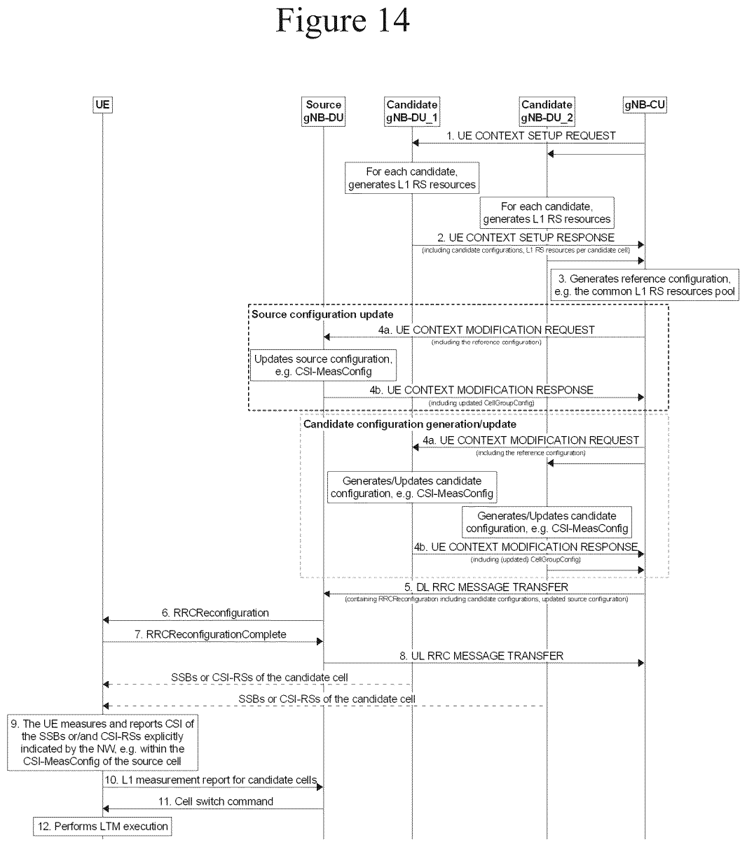

FIG. 14 shows example network signaling for LTM. In one example, the network/basestation explicitly configures/indicates in which cell the RS resources can be measured and/or in which cell the L1 report can be sent (e.g. reuse CSI measurement mechanism). The reference configuration may be generated by the CU (e.g. configured under RRCReconfiguration message) or the source DU. As shown in FIG. 14, the following steps are performed:

1. The CU sends the suggested candidate cell list to the candidate DU via F1 signaling, e.g. UE context setup request message.

2. The candidate DU generates the candidate cell configuration, and/or L1 RS resources for each candidate cell. The candidate DU sends the generated candidate cell configuration, L1 RS resources configuration, and/or TCI-sates configuration to the CU.

3. The CU generates the reference configuration (e.g. including the common L1 RS resources pool, the common L1 measurement pool, or the additional/candidate cell info list) based on the configuration from candidate DUs.

4a/b. The CU triggers source configuration update and/or candidate configuration generation/update based on the reference configuration (e.g. via UE context modification procedure or UE context setup procedure). For the candidate configuration generation/update, the CU sends the reference configuration to the candidate DU via F1 signaling, e.g. UE context setup/modification request message. The message may also include other candidate DUs/cells information, e.g. candidate DU ID(s), candidate cell ID(s), the RS configuration for candidate cell(s), the TCI-state configuration for candidate cell(s), etc. The candidate DU generates/updates candidate cell configurations of candidate cells belonging to that DU, based on the reference configuration from the CU. For example, generate/update the CSI-MeasConfig, e.g. referring to the RS index from the pool. The candidate cell configuration may comprise the L1 measurement configuration and/or TCI state configuration, which can be configured to refer to the RS index from the RS resource configuration pool and/or the additional/candidate cell info list, etc. The candidate DU sends the generated/updated candidate cell configurations to the CU via F1 signaling, e.g. UE context setup/modification request acknowledge message. The message may also include the L1 measurement RS configuration and/or TCI state configuration of candidate cells.

A similar procedure may also be applicable to source configuration update: the CU transfers the reference configuration, received candidate cell information/configuration (e.g. the L1 measurement RS configuration and/or TCI state configuration of candidate cells) to the source DU. The source DU updates its CellGorupConfig, e.g. to reconfigure the CSI-MeasConfig, TCI-state, according to the reference configuration and received candidate cell information/configuration. The source DU sends the updated source configuration to the CU.

5-6. The CU generates RRC reconfiguration message including LTM candidate cell configurations, reference configuration and/or updated source configuration. The CU sends the RRC reconfiguration message to the UE via the source DU.

7-8. The UE responses RRC reconfiguration complete message to the CU via the source DU.

9. The UE measures the L1 RS for candidate cells, which may be explicitly indicated by the NW, e.g. within the CSI-MeasConfig of the source cell.

10. The UE reports the L1 measurements (e.g. CSI report) to the source cell, based on the network/basestation indication, e.g. within the CSI-MeasConfig of the source cell or dynamic scheduling via DCI.

11. The source DU selects one candidate cell as the target for LTM, based on the L1 measurement results. The source DU sends the cell switch command to the UE to indicate the target cell for LTM, e.g. including the target candidate cell configuration index.

12. The UE performs LTM to access/switch to the target cell.

In some embodiments, the step 1 and step 2 can be skipped. For example, the CU or the DU has generated the reference configuration.

In some embodiments, in step 3, for each candidate DU/cell or source DU/cell, the CU may generate/indicate the L1 RS resources to be measured by the UE when the UE accesses to the candidate cell, e.g. generating a mapping between L1 RS resource and other candidate cells, e.g. the additional/candidate cell info list. The CU may then send the additional/candidate cell info list to candidate DUs and source DU (e.g. via step 4a/b).

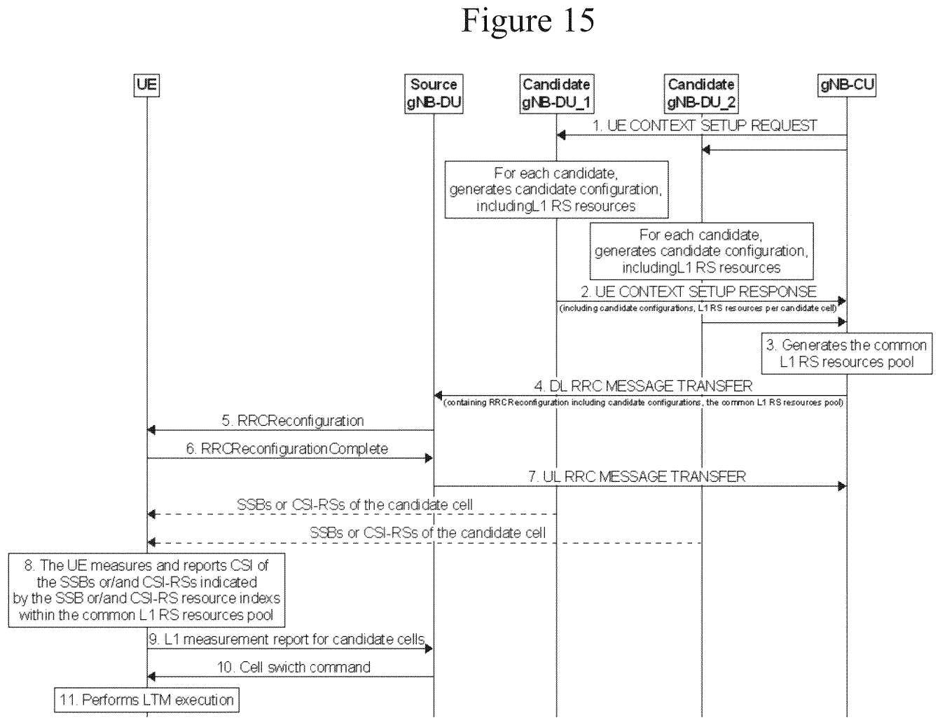

In another embodiment, the network/basestation may not explicitly indicate/configure which candidate cells/RSs to be measured for LTM triggering. FIG. 15 shows another example of network signaling for LTM. The steps for the embodiment shown in FIG. 15 are described below:

1-3. Similar to step 1-3 in FIG. 14.

4-5. The CU generates RRC reconfiguration message including LTM candidate cell configuration, and/or reference configuration (e.g. the common L1 RS resource pool, the additional/candidate cell info list, the common TCI-state list). The CU sends the RRC reconfiguration message to the UE via the source DU.

6-7. The UE responses RRC reconfiguration complete message to the CU via the source DU.

8. The UE measures the L1 RS indicated by the SSB and/or CSI-RS resources indexes within the common L1 RS resources pool. The UE may measure the L1 RS indicated by the network/basestation dynamically, e.g. indicated via MAC CE or DCI.

9. The UE reports the L1 measurements to the source cell, e.g. via MAC CE. The L1 measurement report may be triggered when some events are met, e.g. the L1 measurements of candidate cells becomes better than the network/basestation configured threshold value, the number of the L1 measurements of candidate cells better than the network/basestation configured threshold value is higher than the network/basestation configured number, etc. The L1 measurement report may include the strongest RS indexes, the associated cell IDs, and/or L1-RSRP/RSRQ/SINR for the indicated RS indexes.

10. The source DU selects one candidate cell as the target for LTM. The source DU sends the cell switch command to the UE to indicate the target cell for LTM, e.g. including the target candidate cell configuration index.

11. The UE performs LTM to access/switch to the target cell.

### LTM Execution

The L1/L2 Triggered Mobility (LTM) may then be executed to transfer from a source cell to a target cell. For the LTM execution, there may be a cell switch command. The cell switch command may be conveyed via MAC CE, or DCI. The cell switch command may include at least one of the following information:
The candidate cell configuration index;
TCI state indication of the target cell;
Beam/RS ID of the target cell;
L2 reset Indication, e.g. for PDCP recovery, RLC reestablishment, MAC reset, and/or MAC partial reset;
RACH related information, e.g. CFRA resources to be used for RACH (e.g. preamble index), indication if RACH is needed, indication whether the pre-configured CFRA resource in RRCReconfiguration of a target cell is available or not;
TA or TAG information of the target cell;
BWP ID;
SCell activation/deactivation indication;
C-RNTI;
Indication about whether the cell switch is intra-DU case or inter-DU case; or
Indication about L1 measurement on which candidate cells/beams shall be enabled. After cell switch to the target cell, the UE may perform L1 measurements on the indicated candidate cells/beams, e.g. for subsequent LTM execution.

Upon reception of the cell switch command, the UE applies the configuration of the LTM target candidate cell (i.e. the cell configuration indicated by the candidate cell configuration index in the cell switch command). The UE may perform RACH-based procedure (e.g. CFRA, CBRA) or RACH-less/RACH-skip procedure to switch/access to the target cell. For example, the UE performs a random access procedure towards the target cell, if TA is not available.

During cell switch to the target cell, the UE may inform/notify the target cell about the UE arrival. For CFRA based LTM, the UE may send the Preamble as the notification of the UE arrival. For CBRA based LTM, the UE may send the C-RNTI MAC CE in Msg.3 as the notification of the UE arrival. For RACH-less/RACH-skip LTM, the option may include:

Option 1: the UE sends the target cell ID (e.g. C-RNTI, via the C-RNTI MAC CE) to the target cell with the pre-allocated UL grant, which is associated with a beam/RS/TCI-state indicated by the cell switch command. The pre-allocated UL grant (e.g. configured grant type 1) is pre-configured by the network/basestation (e.g. provided within the candidate cell configuration), and each pre-allocated UL grant is associated with a beam/RS/TCI-state of the candidate cell.

Option 2: the UE sends an SRS to the target cell. The SRS is associated with a beam/RS/TCI-state indicated by the cell switch command. The SRS resource is pre-configured by the network/basestation (e.g. in SRS-Config within the candidate cell configuration), and each SRS is associated with a beam/RS/TCI-state of the candidate cell.

For RACH-based LTM, upon successful completion of RACH procedure, the UE considers the LTM is successfully completed, i.e. successful completion of LTM execution. For RACH-less/RACH-skip LTM, upon successful transmission of a UL message/signaling (e.g. UCI, MAC CE, RRC reconfiguration complete message) to the target cell, upon reception of a first UL scheduling or first DL transmission from the target cell, or upon reception of the DCI addressed to the new C-RNTI for dynamic scheduling of the UL grant or DL assignment from the target cell, the UE considers the LTM is successfully completed.

In an inter-DU example, the target DU may need to be informed/coordinated with some information, e.g. TCI state indication of the target cell, beam/RS ID of the target cell, RACH related information, BWP ID, SCell activation/deactivation, C-RNTI, etc. Regarding how to inform such information with target DU, several options may include:
Option 1: the source DU coordinates with the target DU before sending the cell switch command.
Option 2: the source DU informs target DU after sending the cell switch command.
Option 3: the UE informs the target DU upon completion of the cell switch, e.g. via UL message/signaling to the target cell. The UL message/signaling to inform the completion of LTM can be an RRC message, MAC CE or UCI. The UL signaling may include or indicate at least one of: the target cell ID (e.g. target candidate cell configuration index, C-RNTI), TCI state indication of the target cell, beam/RS ID(s) of the target cell, activated or deactivated SCell ID(s), etc.

There may be an issue for failure detection and handling. A timer may be introduced for LTM, e.g. a LTM timer (t3xx). The timer may be set as a RRC layer timer or a MAC layer timer. The timer may be a t304 timer. The timer value can be configured by the network/basestation, e.g. via RRC reconfiguration message. The timer value may include 5 ms, 10 ms, 20 ms, 40 ms, 50 ms, 100 ms, 200 ms, 500 ms, 1000 ms, etc. The timer starts upon triggering LTM execution, e.g. reception of cell switch command, or upon execution of UE triggered L1/L2 mobility (i.e. when applying a stored candidate cell configuration or upon detection of the execution condition(s) is met). The timer stops upon successful completion of LTM execution. Upon the timer expiring, the UE shall consider the LTM to have failed, i.e. detect the LTM failure. Upon detection of LTM failure, the UE may perform at least one of the following operations:
Alt. 1: trigger RRC re-establishment procedure;
Alt. 2: fall back to the source cell and/or report LTM failure to the NW, e.g. send a LTM failure report to the network/basestation via MAC CE or RRC message; or
Alt. 3: select another cell among the stored candidate cells to perform a new LTM execution, e.g. selecting a candidate cell when a condition of the candidate cell is met, the condition may comprise a RSRP/RSRQ/SINR threshold configured by the network/basestation.

In Alt. 2, the network/basestation may explicitly configure/indicate whether the UE is allowed to fall back to the source cell and/or report LTM failure to the NW upon detection of LTM failure.

The LTM failure report may include at least one of the following information:
failed target candidate cell ID/index;
failure type, e.g. LTM failure;
available L1 and/or L3 measurement results for serving and/or candidate cells; or
recommended/suggested candidate cells and/or beams/RSs, which the network/basestation can consider as candidates for the subsequent LTM execution.

In Alt. 3, the network/basestation may explicitly configure/indicate whether the UE is allowed to perform another LTM execution to other candidate cell(s) after detection of LTM failure. A timer may be introduced to control the time in which the UE can try the new LTM execution after detection of LTM failure, e.g. a LTM failure timer (t3xx). The timer starts upon triggering LTM execution or upon detection of LTM failure. The timer stops upon successful completion of LTM execution. Upon the timer expiring, the UE shall initiate the RRC re-establishment procedure. The timer value may be longer that the LTM timer.

A counter may be introduced to control the number that the UE can try the new LTM execution after detection of LTM failure. Every time the UE tries an LTM execution, the counter value plus one. When the number of attempts for LTM reaches to the maximum counter value, the UE shall initiate the RRC re-establishment procedure. The maximum counter value may be configured by the network/basestation, e.g. via RRC reconfiguration message.

Some embodiments for LTM failure recovery may include:
Upon detection of LTM failure (e.g. t3xx expiry), the UE shall trigger RRC re-establishment. During RRC re-establishment procedure, if the cell selection is triggered by detection of MCG failure (e.g. RLF), LTM failure, handover failure, and the selected cell is a LTM candidate cell, the UE can trigger the LTM execution to the selected cell. Otherwise, the UE shall trigger the legacy/normal re-establishment procedure.
Upon triggering the LTM execution, the UE shall start a LTM timer, and/or a LTM failure timer. upon detection of LTM failure (e.g. the LTM timer expires), and if the LTM failure timer is running, the UE can select another LTM candidate cell to try a new LTM execution. In some examples, the selected candidate cell should meet the threshold set by the NW, e.g. a RSRP threshold. Alternatively, if the LTM failure timer expires, the UE may trigger RRC re-establishment.

### Candidate Cell/Cell Group State

The UE may maintain the candidate cell/cell group (CG) configurations to support the subsequent LTM. Accordingly, the cell/CG state should be defined for each candidate cell/CG. The network/basestation may dynamically select/active a sub-set of configured candidate cells to be measured via L1/L2 signaling, e.g. for the subsequent LTM and/or power saving. Thus, the UE may maintain some candidate cell/CG configuration but the UE is not required to perform L1 measurement on such cell/CG. The candidate cell may include candidate PCell and/or candidate PSCell. The candidate CG may include candidate MCG and/or candidate SCG.

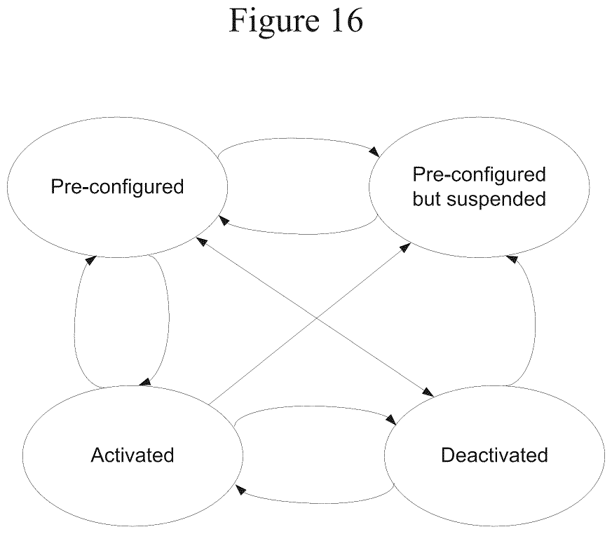

FIG. 16 shows an example of cell or cell group (CG) state transfer. For each candidate Cell/CG, it may have the following state:
Pre-configured state: the UE stores/maintains the cell/CG configuration but the cell/CG configuration is not applied, and the UE performs L1 measurements on the cell/CG;
Pre-configured but suspended state: the UE stores/maintains the cell/CG configuration but the cell/CG configuration is not applied, and the UE stops/suspends the L1 measurements on the cell/CG;
Activated state: the UE behavior is the same as the current activated serving cell/CG, e.g. perform DL reception/UL transmission with the cell, perform radio link monitoring and/or beam failure detection on the cell, perform measurements on the cell, etc; or
Deactivated state: the UE behavior is the same as the current deactivated serving cell/CG, e.g. suspend DL reception/UL transmission with the cell, perform radio link monitoring and/or beam failure detection on the cell if indicated by the network/basestation (e.g. for deactivated SCG, the bfd-and-RLM is configured to true).

The candidate cell/CG in a pre-configured but suspended state may not consume any UE capability related to L1 measurement performing. The candidate cell/CG in a pre-configured state and/or pre-configured but suspended state may not consume any UE capability for the serving cell (including the activated and deactivated serving cell).

When receiving LTM candidate cell/CG configurations from the network/basestation, the UE may consider the stored candidate cells/CGs to be in a pre-configured state or pre-configured but suspended state. To go from pre-configured state to a pre-configured but suspended state may include:
When receiving a network/basestation signaling to indicate that L1 measurements on the candidate cells/CGs are not enabled/allowed/activated, the UE considers the candidate cell/CG in pre-configured but suspended state, and stops/suspends the L1 measurements on the cell/CG.

To go from a pre-configured but suspended state to a pre-configured state may include:
When receiving a network/basestation signaling to indicate that L1 measurements on the candidate cells/CGs are enabled/allowed/activated, the UE considers the candidate cell/CG in pre-configured state, and starts/re-starts the L1 measurements on the cell/CG.

To go from a pre-configured state to an activated state may include:
When receiving a network/basestation signaling (e.g. cell switch command) to indicate that the candidate cells/CG is the target for cell switch or the candidate cells/CG is activated (e.g. for SCell or SCG), the UE applies the cell configuration of the target cell, performs cell switch to the target cell, and/or considers the cell is in activated state.

To go from a pre-configured state to a deactivated state may include:
When receiving a network/basestation signaling (e.g. cell switch command) to indicate that the candidate cells/CG is deactivated (e.g. for SCell or SCG), the UE applies the cell configuration, and/or considers the cell/CG is in deactivated state.

To go from an activated state to a deactivated state/pre-configured state/pre-configured but suspended state may include: when receiving a network/basestation signaling (e.g. cell switch command), the activated source cell(s) may be transferred into deactivated state/pre-configured state/pre-configured but suspended state.

To go from a deactivated state to an activated state/pre-configured state/pre-configured but suspended state may include: when receiving a network/basestation signaling (e.g. cell switch command), the deactivated source cell(s) may be transferred into activated state/pre-configured state/pre-configured but suspended state. For the state transfer between activated and deactivated, it may be at least it is applicable to SCell and SCG.

### LTM in NR-DC

LTM may be supported in NR-DC scenario (e.g. for intra-SN case). The following examples may be considered:
Example 1: LTM is configured in MN only, e.g. for intra-MN PCell change with/without SCell change;
Example 2: LTM is configured in SN only, e.g for intra-SN PSCell change with/without SCell change; or
Example 3: LTM is configured independently in both MN and SN.

In some examples, the LTM within one node may have no impact on the other node, e.g. intra-frequency LTM, the LTM within one node can be transparent to the other node. Specifically, there may be no need to perform inter-node coordination before sending cell switch command to trigger the LTM. MN/MCG and SN/SCG may maintain a pool/list of candidate cells within each node (e.g. the candidate cell within the pool is configured for intra-frequency LTM):
If the LTM is triggered for candidate cell change among the pool of MCG, the MCG is not required to inform the SCG, i.e. transparent to the other CG, vice versa.
If the L1/L2 mobility is triggered for candidate cell change outside the pool of MCG, the MCG should coordinate with the SCG before sending the cell switch command to the UE, vice versa.

In an example where the LTM within one node has an impact on the other node, e.g. inter-frequency LTM, the MN and the SN can also perform the coordination when preparing the candidate cell configuration. For the candidate cell in MN, the SCG configuration may also be included in the candidate cell configuration, e.g. including MRDC-SecondaryCellGroupConfig IE. The triggering of LTM execution may trigger the PCell change with PSCell change. For the candidate cell in MN, a list of allowed candidate PSCell can be pre-configured. Upon triggering the LTM in MN, the MN can select one candidate PSCell from the allowed candidate PSCell list to perform the LTM for PCell change with PSCell change. In this example, the UE may be required to report the L1 measurements on candidate PSCells to the MN as well.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication, performed by user equipment, comprising:
receiving a configuration message that includes configurations for one or more Layer 1 (“L1”) or Layer 2 (“L2”) Triggered Mobility (“LTM”) candidate cells;
storing the configurations for the LTM candidate cells;
transmitting a measurement report with L1 measurements for at least one of the LTM candidate cells, based on an L1 measurement report configuration comprising a maximum number of reference signalings reported in one L1 measurement report and a maximum number of cells reported in the one L1 measurement report;
receiving a cell switch command to indicate a target LTM candidate cell from the LTM candidate cells; and
performing an LTM cell switch to the target LTM candidate cell.

2. The method of claim 1, wherein the configurations for the LTM candidate cells comprise a list of candidate cell configurations.

3. The method of claim 1, wherein configuration for each of the LTM candidate cells comprises a candidate cell configuration index.

4.-7. (canceled)

8. The method of claim 1, wherein the configurations for the LTM candidate cells comprise a common L1 measurement configuration pool.

9. (canceled)

10. The method of claim 1, wherein the configurations for the LTM candidate cells comprise an information list that indicates which L1 measurement configurations are associated with which of the LTM candidate cells.

11.-15. (canceled)

16. The method of claim 1, further comprising:
sending, a UL signaling to the target LTM candidate cell, to inform completion of the LTM cell switch.

17. The method of claim 16, wherein the UL signaling comprises or indicates a target LTM candidate cell identification.

18.-24. (canceled)

25. A method for wireless communication performed by a base station comprising:
transmitting a configuration message that includes configurations for one or more Layer 1 (“L1”) or Layer 2 (“L2”) Triggered Mobility (“LTM”) candidate cells;
receiving a measurement report with L1 measurements for at least one of the LTM candidate cells; and
transmitting a cell switch command to indicate a target LTM candidate cell from the LTM candidate cells, and to trigger execution of an LTM cell switch to the target LTM candidate cell.

26. The method of claim 25, wherein the configurations for the LTM candidate cells comprise a list of candidate cell configurations.

27. The method of claim 25, wherein configuration for each of the LTM candidate cells comprise a candidate cell configuration index.

28.-30. (canceled)

31. The method of claim 25, wherein the configurations for the LTM candidate cells comprise a common L1 measurement configuration pool.

32. (canceled)

33. The method of claim 25, wherein the configurations for the LTM candidate cells comprise an information list that indicates which L1 measurement configurations are associated with which of the candidate cells.

34.-37. (canceled)

38. The method of claim 25, further comprising:
receiving, a UL signaling to the target LTM candidate cell, to inform completion of the LTM cell switch, wherein the UL signaling comprises or indicates a target LTM candidate cell identification.

39. A wireless communications apparatus comprising a processor and a memory, wherein the processor is configured to read code from the memory to:
receive a configuration message that includes configurations for one or more Layer 1 (“L1”) or Layer 2 (“L2”) Triggered Mobility (“LTM”) candidate cells;
store the configurations for the LTM candidate cells;
transmit a measurement report with L1 measurements for at least one of the LTM candidate cells, based on an L1 measurement report configuration comprising a maximum number of reference signalings reported in one L1 measurement report and a maximum number of cells reported in the one L1 measurement report;
receive a cell switch command to indicate a target LTM candidate cell from the LTM candidate cells; and
perform a LTM cell switch to the target LTM candidate cell.

40. (canceled)

41. A wireless communications apparatus comprising a processor and a memory, wherein the processor is configured to read code from the memory to execute the method of claim 25.

42. A method performed by a centralized unit (CU) of a base station in a wireless communication network, the method comprising:
indicating a suggested candidate cell for a Layer 1 (“L1”) or Layer 2 (“L2”) Triggered Mobility (“LTM”) cell switching to a candidate distributed unit (DU);
receiving at least one configuration generated by the candidate DU in response to the DU receiving the indication of the suggested candidate cell, the at least one configuration comprising at least one of a candidate cell configuration, a layer-1 (L1) reference signal resource (RS) configuration, or a TCI-state configuration.

43. The method of claim 42, further comprising:
transmitting a reference configuration to the candidate DU, wherein the reference RS configuration is transmitted via a UE context modification request message.

44. The method of claim 42, wherein the reference RS configuration is generated based on the at least one configuration.

45. The method of claim 42, further comprising:
transmitting an information of other candidate DU or candidate cell to the candidate DU, wherein the information comprises at least one of a candidate DU ID, a candidate cell ID, or a candidate TCI-state configuration; and
receiving an updated candidate cell configuration from the candidate DU.

46. The method of claim 42, further comprising:
transmitting the received at least one configuration, to a source DU, wherein the received at least one configuration includes the TCI-state configuration; and
receiving an updated source cell configuration from the source DU.
